(19) United States
(12) Patent Application Publication
(10) Pub. No.: US 2017/0292295 A1
(43) Pub. Date: Oct. 12, 2017

(54) Bike Lock

(71) Applicant: Jacinto Alvarado, Willow Springs, IL (US)

(72) Inventor: Jacinto Alvarado, Willow Springs, IL (US)

(21) Appl. No.: 15/470,580

(22) Filed: Mar. 27, 2017

Related U.S. Application Data
(60) Provisional application No. 62/319,083, filed on Apr. 6, 2016.

(51) Int. Cl. E05B 71/00; E05B 73/00; E05B 17/10

(52) U.S. Cl. CPC E05B 71/00; E05B 17/10; E05B 73/0005

(57) ABSTRACT

The present invention relates to a bicycle lock comprising a lock body and set of arms. The lock body is mountable on the seat of the bicycle. The arms extend from the lock body and terminate in locking surfaces. The locking surfaces are secured together by a locking element. The lock body and arms comprise an integrated textile fabric and steel cable structure simultaneously resistant to common sawing and slicing attacks. The lock body secures the bicycle seat while the arms are threaded through and around bicycle components to attach to a stationary object.

### FIELD OF THE INVENTION

This invention generally relates to bicycle (i.e., “bike”) security accessories and, in particular, devices used to prevent unauthorized utilization of the bike or removal of its components.

### BACKGROUND OF THE INVENTION

Bike locks, or devices which are designed to prevent bike theft or unauthorized bike operation, are well known in the art. Generally, bike locks take the form of a cable, bar, or other strong force-bearing body that is arranged around a portion of a bike and then secured to itself, often with a combination or key lock. Particularly as bike construction becomes more modular, the goal of preventing important bike components from theft reveals limitations on the prior art as those devices can only secure those bike components which are shaped or oriented in a way that allows a two-dimensional cable or bar body to prevent movement. While a bike's frame, wheels, and drivetrain may be secured together with a cable or chain-link, handlebars, the bike's seat, and bike accessories may be left unsecured.

Furthermore, bike locks, depending on their construction, may be defeated by using a single tool. Bike locks which incorporate a plastic-insulated wire cable may be defeated by bolt cutters which use an overwhelming shearing force. Bike locks which specifically attempt to defeat bolt cutters, e.g., by using exaggerated bar or cable diameters to prevent bolt cutter jaws from engaging the lock, may yet be defeated by hand saw-type tools where the thief is given a sufficient amount of time. Other bike locks which utilize ultra-dense metal alloys to defeat both hand saws and bolt cutter-type tools are often prohibitively heavy.

Installing bike locks may be a challenge at night where the user is attempting to thread a cable or chain-link member around and through bike components and against immobile ground-level objects (e.g., bike rack). Low-light environments hinder the user's ability to feed bike lock portions around bike components and secure the locking mechanism, leading to improperly-secured bike components and perhaps even injury where sharp drivetrain edges are exposed.

Because bike locks are often made from dense materials or incorporate coils or links of stiff, strong steel alloys, transporting the locks themselves may be problematic. Bike locks may not be easily stowable on the bike itself and too bulky and/or heavy to be carried on the user's person.

Certain examples in the prior art help illustrate common limitations. U.S. Pat. No. 4,856,831 discloses a Bicycle Cover with Lock Holes. This reference describes simply a four-portioned weatherproof covering for an entire bicycle. The covering is threaded with drawstring-type features to tightly enclose the covered bicycle when in use. The covering is provided with holes such that a locking means can be placed through the covering to secure the covered bicycle to an external immovable object. This reference does not describe any means by which the lock is self-contained or stowed.

U.S. Pat. No. 4,966,382 discloses a Bicycle Accessory for Carrying a Shackle. This reference is, at its most basic, a bicycle-attaching bracket with grooves which accept a coiled cable (i.e., “shackle”) and lock. The bracket is attached to the tubular bike frame via a clamp and secures the coiled cable/shackle between either clip-closed grooved jaws or one grooved lower jaw and elastic band. This reference does not describe a portion that may be used to cover the bike's seat or any illuminating means from which the user may benefit in low-light conditions. Further, this reference fails to describe how the invention may be removed by the user for transport.

U.S. Pat. No. 5,251,464 discloses a Bicycle Lock with Storable Reel Cable. This is pertinent mostly as prototypical example of a retractable cable lock container. The '464 patent describes a cable housing around a tubular journal (accepting a part of the bicycle's frame) in which the cable is wound with the aid of a coil spring. The cable's ends feature a key or rotary lock to secure each other when the cable is deployed from the housing and in-use. This reference does not disclose any cover, for the bicycle's seat or otherwise, nor does it disclose any illuminating means for low-light conditions.

U.S. Pat. No. 5,676,288 discloses a Bicycle Cover. This reference describes a weatherproof protective covering that, when deployed, generally covers the bike's seat and handlebars. This reference incorporates an elastic member to allow for a tight fit around the bike's components as well as a securing strap locking the cover in place. This reference also describes a self-storage means by which the cover, when stowed, packs into itself with a zipper. This reference does not describe any illuminating means, self-stowage ability, or novel approach to defeating destructive theft threats.

U.S. Pat. No. 7,225,956 discloses a Rubber Locking Device for Bicycle Seat Bag. This reference generally discloses a means to secure a bike-transportable container under the bike seat. This reference describes a set of fasteners, spacers, and strips which engage the “U-frame” underneath the bike seat to secure the “seat bag.” This reference does not describe any cover, cable-type portion, cable locking means, or illuminating means.

A review of the prior art reveals that existing bike lock technology is not designed in any fashion comprehensive of security threats and portability considerations. While no bike lock or other security feature will be invincible, an object to any such system is to at least make the user's bike a less vulnerable target than other bikes in the vicinity, particularly in urban environments.

Generally, the present invention's innovations, as the Detailed Description will elaborate, address the shortcomings of the prior art without sacrificing the configuration requirements necessary to ensure the invention's universal compatibility.

### BRIEF SUMMARY OF THE INVENTION

The present invention is a bike lock comprising a lock body adapted to fit over a bike seat or other bike component. A plurality of arm members extends from the lock body to intertwine the bike frame and components. The arm members are secured together in tension, maintaining the lock body in a secured position over the bike seat. The lock body and arm members are made from shear and abrasion-resistant materials to prevent most security threats. The bike lock provides its bike with substantial theft protection for the bike itself and its components.

### BRIEF DESCRIPTION OF THE DRAWINGS

The accompanying figures and drawings, incorporated into and forming part of the specification, service to further illustrate the present invention, its various principles and advantages, and its varying embodiments:

FIG. 1A illustrates an un-deployed bike lock.

FIG. 1B illustrates a second embodiment of an un-deployed bike lock.

FIG. 2 illustrates a bike lock deployed onto a bike.

FIG. 3A illustrates a partially self-stowed bike lock.

FIG. 3B illustrates a self-stowed bike lock.

FIG. 3C illustrates a second embodiment of a partially self-stowed bike lock.

FIG. 4A illustrates an enlarged view of a bike lock arm member end.

FIG. 4B illustrates a cross sectional view of a bike lock arm member end.

FIG. 5 illustrates a perspective view of a bike lock deployed onto a bike.

### DETAILED DESCRIPTION

Provided is a novel bike lock. The bike lock comprises first a lock body that has a top portion and a bottom portion. The top portion has a first and second fastening edge, each located opposite the other along the perimeter of top portion. Fasteners are disposed onto the fastening edges. Arm members extend through journals on the bottom portion. Each arm member has at least two arm member ends, each arm member end having at least one locking surface. The locking surfaces may be hole-bearing (e.g., a grommet) to which a shackle may be adaptively inserted or pin-bearing, for insertion into a locking receptacle. A locking element secures the locking surfaces together.

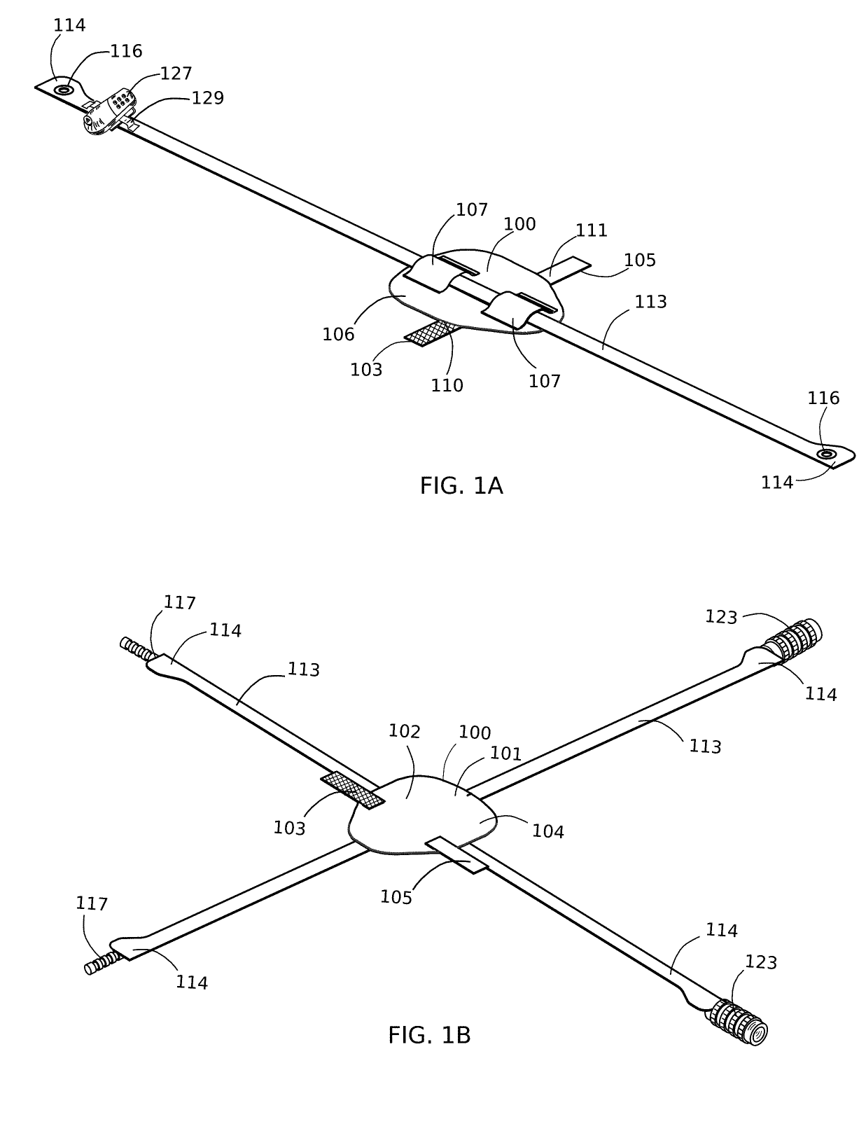

FIG. 1A illustrates an exemplary bike lock. A lock body 100 is shown having two journals 107 on the lock body bottom surface 106. An arm member 113 extends through journals 107 terminating in two arm member ends 114. A grommet locking surface 116 is disposed on each arm member end 114. A first fastening means 103 provides hook fasteners 110 and second fastening means 105 provides look fasteners 111. A loop 129 is disposed onto one arm member end and a self-powered light emitting diode (“LED”) light source is attached to the loop 129.

FIG. 1B illustrates a second embodiment of a bike lock. A top surface 101 of a lock body 100 has a first side 102 and a second side 104. The first side 102 is provided with a first fastening means 103. The second side 104 is provided with a second fastening means 105. Two arm members 113 are provided each ending in two arm member ends 114. One arm member end 114 of each arm member 113 is provided with a pin locking surface 117. The other arm member end 114 of each arm member 113 is provided with a pin lock 123.

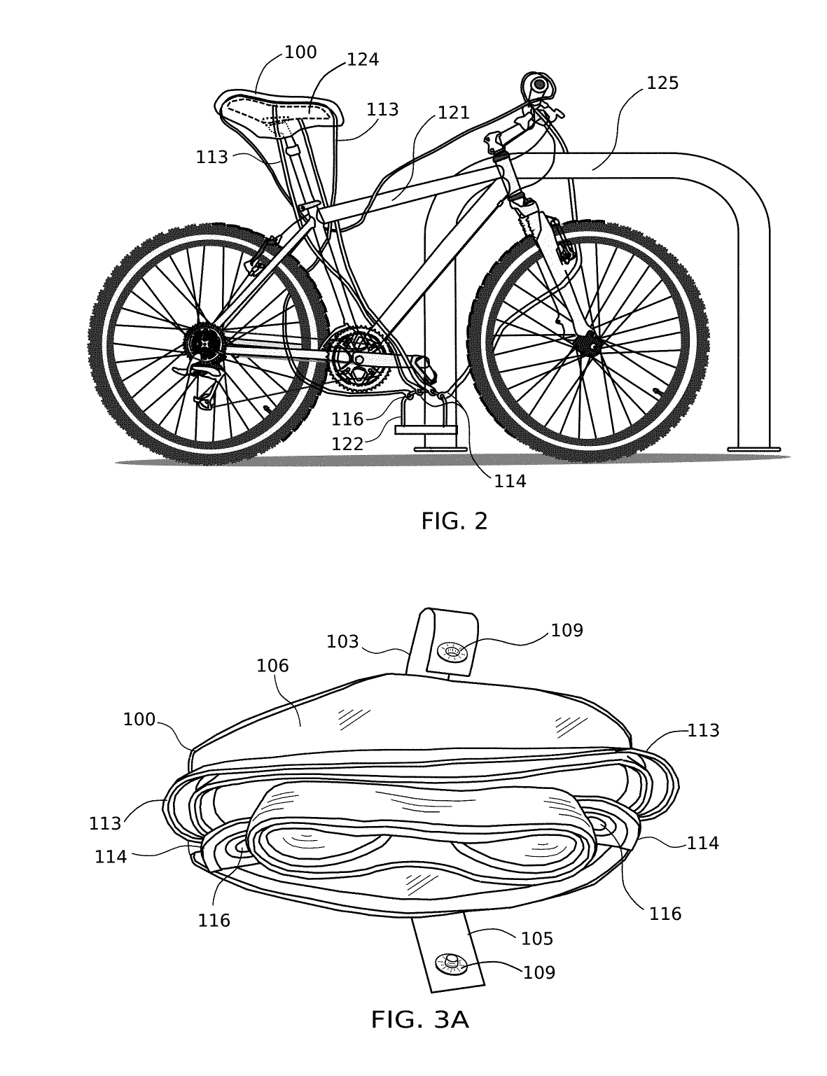

FIG. 2 illustrate an exemplary deployment of a bike lock. The lock body 100 is placed on a bike seat 124. Two arm members 113 descend from the lock body and are interwoven with the bike frame surfaces 121 and against a bike rack 125. The arm member ends 114 are collected and a shackle-bearing lock 122 secures the arm member ends 114 through grommets 116 disposed thereon.

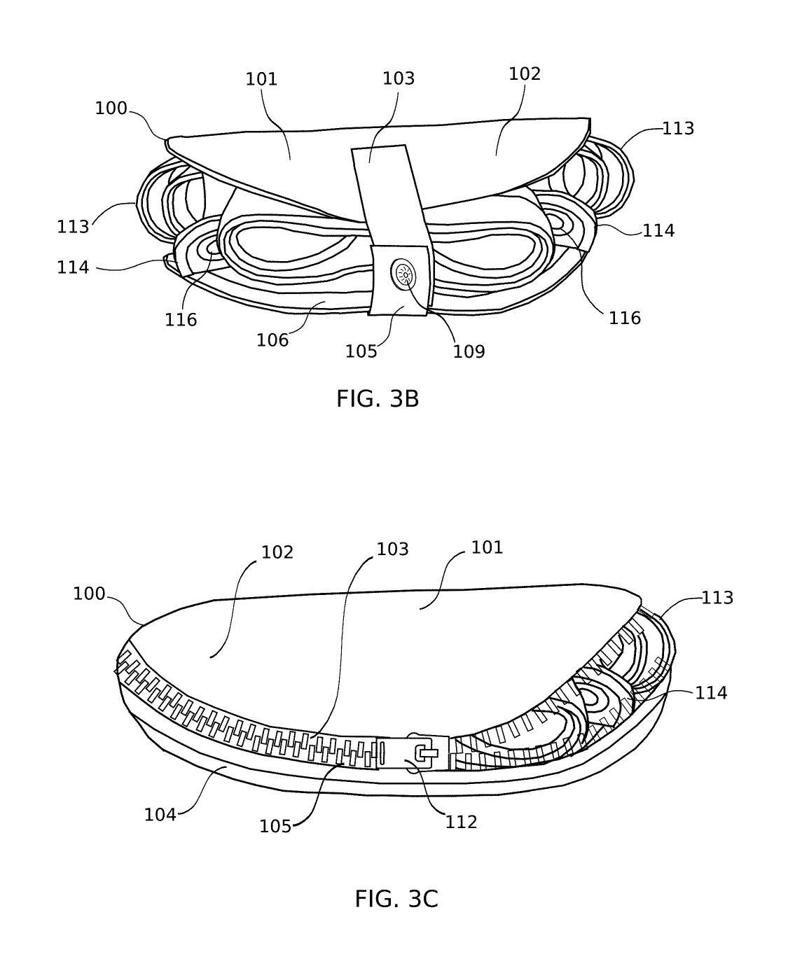

FIG. 3A illustrates an exemplary bike lock in the process of being self-stowed. Two arm members 113 are collapsed within a folding lock body 100. Grommets are disposed on the arm member ends 114 and collected substantially within the perimeter of the lock body lower surface 106. Snaps 109 are disposed onto the first fastening means 103 and second fastening means 105.

FIG. 3B illustrates an exemplary bike lock in a self-stowed configuration. Two arm members 113 are collapsed within a folded lock body 100. Grommets 116 are disposed on the arm member ends 114 and kept substantially within the perimeter of the lock body lower surface 106. A first fastening means is disposed on a first side 102 of the lock body top surface 101. Snaps 109 secure the first fastening means 103 to a second fastening means 105, keeping the lock body folded around and securing the arm members 113 and arm member ends 114.

FIG. 3C illustrates an alternate embodiment of a self-stowed bike lock. A lock body 100 is substantially folded over an arm member 113. A zipper first fastening means 103 is disposed along the perimeter of a first side 102 of the lock body top surface 101. A zipper second fastening means 105 is disposed along the perimeter of a second side 104 of the top surface 101. A slider 112 is disposed onto the perimeter of the lock body top surface 101. The slider 112 can enclose the arm member 113 and arm member end 114 within the folded lock body 100.

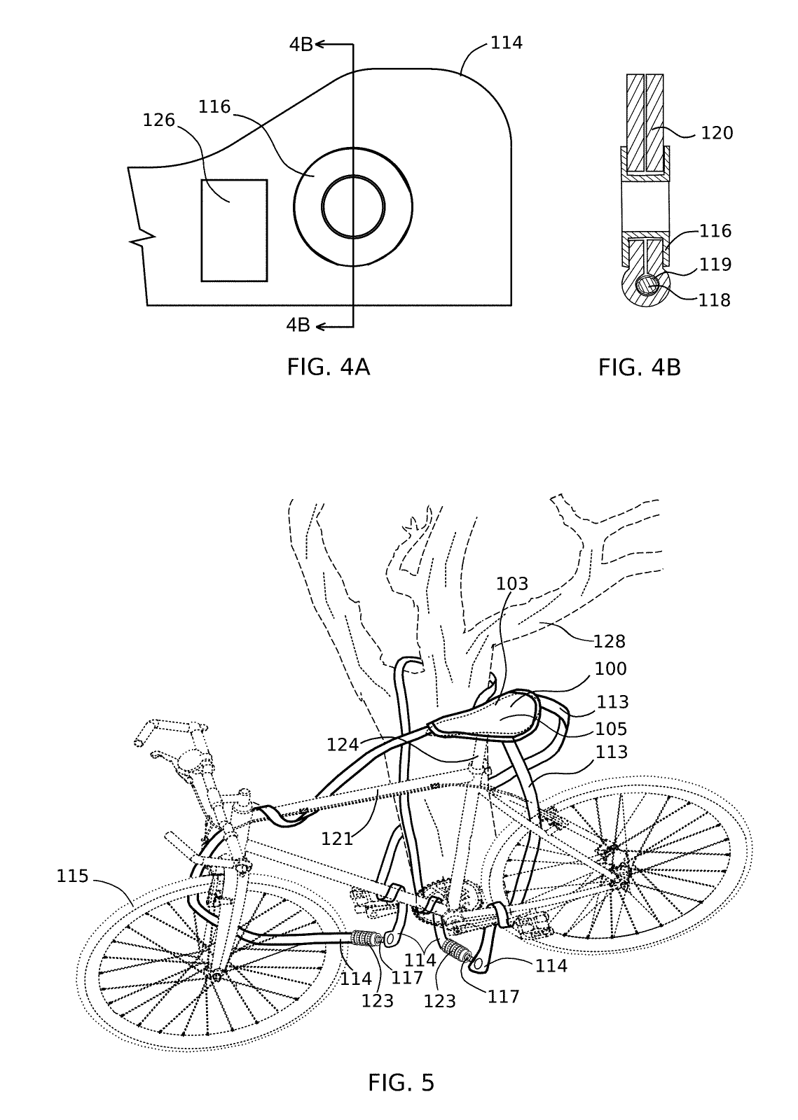

FIG. 4A illustrates an exemplary arm member end. A grommet 116 is disposed onto the arm member end 114 proximate to a glow-in-the-dark lighting element 126.

FIG. 4B is a cross sectional view of the arm member end of FIG. 4A. A steel cable 118 is disposed within a water impermeable layer 119. A woven textile fiber jacket 120 envelopes the water impermeable layer 119 and steel cable 118 disposed therein. A grommet 116 perforates the woven textile fiber jacket 120 and allows a shackle to connect the arm member end 114 to another arm member end.

FIG. 5 illustrates an exemplary bike lock deployed onto a bike. A lock body 100 is placed onto a bike seat 124. Two arm members 113 descend from the lock body 100. The bike 115 is leaned against a tree 128. The arm members 113 are intertwined around the bike surfaces 121. The arm members each have an arm member end 114 terminating in a pin 117 and another arm member end 114 terminating in a pin lock 123. The pins 117 and engaged to the pink lock 123, securing the arm member ends 114 together and preventing the separation of bike components or the bike 115 itself from the tree 128.

A water impermeable (e.g., polymer) layer ensheaths the steel cable to prevent environmental moisture from compromising the steel cable. A woven textile fiber jacket surrounds the outer surface of the water impermeable layer to resist abrasion. Recycled fire hoses, polymer cable, metal fabric, or other durable materials which are flexible though abrasion-resistant may be used in the jacket.

The lighting elements disposed onto the arm member ends and proximate to the locking surfaces enable the bike lock user to use the bike lock in low light conditions. The lighting elements may be battery powered light emitting diodes (LED), photoluminescent material.

Fastening means may include snaps, zippers, or other removably-securable means such that the user can collapse the lock body around the arm members as the arm members themselves are collapsed. The locking element may be a standard key lock, combination lock, pin lock, or a shackle-bearing implement adapted to secure the locking surfaces together.

When in use, the lock body is first placed onto a bike's seat or other bike component. The arm members are successively intertwined through the bike's components. The arm member ends are placed together and the locking elements secure the locking surfaces together. The arm members are kept in tension, forcing the lock body onto the bike seat. The lighting elements facilitate the user with engaging the bike components with the lock body and arm members. The bike lock's cable woven textile fiber jacket resists shear force and the internal cable resists saw-type threats. The bike lock may be used to render a bike inoperable alone, or along with a bike rack or stationary object against which the bike lock may secure the bike and its components.

When the user desires to utilize the bike, the locking element is disengaged from the locking surfaces. The arm members are disengaged from the bike frame and components. The lock body is removed from the bike seat and the arm members are collapsed under the bottom portion of the lock body. The fasteners are used to self-securely collapse the lock body around and enclose the collapsed arm members, resulting in a self-contained bike lock package.

While the bike lock invention has been described with reference to certain embodiments, various modifications thereof will be apparent to those skilled in the art without departing from the scope of the invention.

I claim:

1. A bike lock comprising:
a lock body, the lock body having a top surface and a bottom surface, the top surface having a first fastening means and second fastening means, the first fastening means located on a first side of the top surface, the second fastening means located on a second side of the top surface, the first side and second side being oriented substantially opposite each other on the top surface, the bottom surface having at least one journal, the lock body being made from woven textile fiber having high abrasion resistance;
at least one arm member extending through the at least one journal, the at least one arm member having a plurality of arm member ends, the plurality of arm member ends each having a locking surface, the at least one arm member further comprising a steel cable, a water impermeable layer ensheathing the steel cable, and a woven textile fiber jacket having high abrasion resistance ensheathing the water impermeable layer;
a locking element adapted to removably secure the locking surfaces together.

2. The bike lock of claim 1, wherein a lighting element is disposed onto at least one arm member end.

3. The bike lock of claim 2, wherein the lighting element is a glow-in-the-dark element chargeable following an exposure to a light source.

4. The bike lock of claim 3, wherein the glow-in-the-dark element is a layer impregnated with a phosphor based photolumines cent material.

5. The bike lock of claim 2, wherein the lighting element is a battery-powered LED light source.

6. The bike lock of claim 1, wherein the first fastening means is a hook fastener and the second fastening means is a loop fastener.

7. The bike lock of claim 1, wherein the first fastening means and second fastening means are snaps.

8. The bike lock of claim 1, wherein the lock body further comprises a slider, the first fastening means being a zipper and the second fastening means being a zipper.

9. The bike lock of claim 1, wherein each locking surface is a grommet and the locking element is a lock having a shackle.

10. The bike lock of claim 1, wherein each locking surface is a pin and the locking element is a pinlock.

11. The bike lock of claim 2, wherein the first fastening means is a hook fastener and the second fastening means is a loop fastener.

12. The bike lock of claim 2, wherein the first fastening means and second fastening means are snaps.

13. The bike lock of claim 2, wherein the lock body further comprises a slider, the first fastening means being a zipper and the second fastening means being a zipper.

14. The bike lock of claim 2, wherein each locking surface is a grommet and the locking element is a lock having a shackle.

15. The bike lock of claim 2, wherein each locking surface is a pin and the locking element is a pinlock.

16. A method of securing a bike, comprising the steps of:
providing a bike lock, the bike lock comprising a lock body, the lock body having a top surface and a bottom surface, the top surface having a first fastening means and second fastening means, the first fastening means located on a first side of the top surface, the second fastening means located on a second side of the top surface, the first side and second side being oriented substantially opposite each other on the top surface, the bottom surface having at least one journal, the lock body being made from a woven textile fiber jacket having high abrasion resistance, the bike lock further comprising at least one arm member extending through the at least one journal, the at least one arm member having a plurality of arm member ends, the plurality of arm member ends each having a locking surface, the at least one arm member further comprising a steel cable, a water impermeable layer ensheathing the steel cable, and a woven textile fiber jacket having high abrasion resistance ensheathing the water impermeable layer, the bike lock further comprising a locking element adapted to removably secure the locking surfaces together;
placing the lock body on top of a seat potion of the bike;
wrapping a first arm member end around at least one surface of the bike;
wrapping a second arm member end around at least one surface of the bike such that when the locking surfaces are placed together, the tension maintained by the plurality of arm member end secures the lock body against the seat portion;
placing the locking surfaces together; and
securing the locking surfaces together with the locking element.

17. The method of claim 17, further comprising activating a lighting element disposed onto at least one arm member end.
